(19) United States
(12) Patent Application Publication
(10) Pub. No.: US 2025/0027497 A1
(43) Pub. Date: Jan. 23, 2025

(54) AXIAL PUMP AND RISER

(71) Applicant: Molten Metal Equipment Innovations, LLC, Middlefield, OH (US)

(72) Inventor: Paul V. Cooper, Chesterland, OH (US)

(73) Assignee: Molten Metal Equipment Innovations, LLC, Middlefield, OH (US)

(21) Appl. No.: 18/909,191

(22) Filed: Oct. 8, 2024

Related U.S. Application Data
(63) Continuation of application No. 17/826,111, filed on May 26, 2022, now Pat. No. 12,146,508.

(51) Int. Cl. F04D 7/00; B22D 37/00; F04D 3/00; F04D 7/06; F04D 13/06

(52) U.S. Cl. CPC F04D 7/00; B22D 37/00; F04D 3/00; F04D 7/065; F04D 13/06

(57) ABSTRACT

A device for pumping molten metal includes a pump configured to pump molten metal, wherein the pump comprises (i) a motor, (ii) a shaft having a first end connected to the motor, and a second end connected to a rotor, wherein the rotor is configured to push molten metal upwards as it rotates. At least part of the shaft and the rotor are positioned in a conduit of a riser. The riser has an outer surface, a front, a bottom, a two-stage conduit, an inlet and an outlet above the inlet and below the motor. The two-stage conduit has a lower stage and a an upper stage, wherein the lower stage is generally cylindrical and the upper stage has a circular cross-sectional portion and one or more lobes extending from and in communication with the circular cross-sectional portion.

### CROSS REFERENCE TO RELATED APPLICATIONS

This is a Continuation of U.S. patent application Ser. No. 17/826,111 filed May 26, 2022 and entitled AXIAL PUMP AND RISER, the contents of which is incorporated by reference in its entirety.

### BACKGROUND

As used herein, the term “molten metal” means any metal or combination of metals in liquid form, such as aluminum, copper, iron, zinc, and alloys thereof. The term “gas” means any gas or combination of gases, including argon, nitrogen, chlorine, fluorine, Freon, and helium, which are released into molten metal.

Known molten-metal pumps include a pump base (also called a housing or casing), one or more inlets (an inlet being an opening in the housing to allow molten metal to enter a pump chamber), a pump chamber of any suitable configuration, which is an open area formed within the housing, and a discharge, which is a channel or conduit of any structure or type communicating with the pump chamber (in an axial pump the chamber and discharge may be the same structure or different areas of the same structure) leading from the pump chamber to an outlet, which is an opening formed in the exterior of the housing through which molten metal exits the casing. An impeller, also called a rotor, is mounted in the pump chamber, and is connected to a drive device. The drive shaft is typically an impeller shaft connected to one end of a motor shaft; the other end of the drive shaft being connected to an impeller. Often, the impeller (or rotor) shaft is comprised of graphite and/or ceramic, the motor shaft is comprised of steel, and the two are connected by a coupling. As the motor turns the drive shaft, the drive shaft turns the impeller and the impeller pushes molten metal out of the pump chamber, through the discharge, out of the outlet and into the molten metal bath. Most molten metal pumps are gravity fed, wherein gravity forces molten metal through the inlet and into the pump chamber as the impeller pushes molten metal out of the pump chamber. Other molten metal pumps do not include a base or support posts and are sized to fit into a structure by which molten metal is pumped. Most pumps have a metal platform, or super structure, that is either supported by a plurality of support posts attached to the pump base, or unsupported if there is no base. The motor is positioned on the superstructure if a superstructure is used.

This application incorporates by reference the portions of the following documents that are not inconsistent with this disclosure: U.S. Pat. No. 4,598,899, issued Jul. 8, 1986, to Paul V. Cooper, U.S. Pat. No. 5,203,681, issued Apr. 20, 1993, to Paul V. Cooper, U.S. Pat. No. 5,308,045, issued May 3, 1994, by Paul V. Cooper, U.S. Pat. No. 5,662,725, issued Sep. 2, 1997, by Paul V. Cooper, U.S. Pat. No. 5,678,807, issued Oct. 21, 1997, by Paul V. Cooper, U.S. Pat. No. 6,027,685, issued Feb. 22, 2000, by Paul V. Cooper, U.S. Pat. No. 6,124,523, issued Sep. 26, 2000, by Paul V. Cooper, U.S. Pat. No. 6,303,074, issued Oct. 16, 2001, by Paul V. Cooper, U.S. Pat. No. 6,689,310, issued Feb. 10, 2004, by Paul V. Cooper, U.S. Pat. No. 6,723,276, issued Apr. 20, 2004, by Paul V. Cooper, U.S. Pat. No. 7,402,276, issued Jul. 22, 2008, by Paul V. Cooper, U.S. Pat. No. 7,507,367, issued Mar. 24, 2009, by Paul V. Cooper, U.S. Pat. No. 7,906,068, issued Mar. 15, 2011, by Paul V. Cooper, U.S. Pat. No. 8,075,837, issued Dec. 13, 2011, by Paul V. Cooper, U.S. Pat. No. 8,110,141, issued Feb. 7, 2012, by Paul V. Cooper, U.S. Pat. No. 8,178,037, issued May 15, 2012, by Paul V. Cooper, U.S. Pat. No. 8,361,379, issued Jan. 29, 2013, by Paul V. Cooper, U.S. Pat. No. 8,366,993, issued Feb. 5, 2013, by Paul V. Cooper, U.S. Pat. No. 8,409,495, issued Apr. 2, 2013, by Paul V. Cooper, U.S. Pat. No. 8,440,135, issued May 15, 2013, by Paul V. Cooper, U.S. Pat. No. 8,444,911, issued May 21, 2013, by Paul V. Cooper, U.S. Pat. No. 8,475,708, issued Jul. 2, 2013, by Paul V. Cooper, U.S. patent application Ser. No. 12/895,796, filed Sep. 30, 2010, by Paul V. Cooper, U.S. patent application Ser. No. 12/877,988, filed Sep. 8, 2010, by Paul V. Cooper, U.S. patent application Ser. No. 12/853,238, filed Aug. 9, 2010, by Paul V. Cooper, U.S. patent application Ser. No. 12/880,027, filed Sep. 10, 2010, by Paul V. Cooper, U.S. patent application Ser. No. 13/752,312, filed Jan. 28, 2013, by Paul V. Cooper, U.S. patent application Ser. No. 13/756,468, filed Jan. 31, 2013, by Paul V. Cooper, U.S. patent application Ser. No. 13/791,889, filed Mar. 8, 2013, by Paul V. Cooper, U.S. patent application Ser. No. 13/791,952, filed Mar. 9, 2013, by Paul V. Cooper, U.S. patent application Ser. No. 13/841,594, filed Mar. 15, 2013, by Paul V. Cooper, and U.S. patent application Ser. No. 14/027,237, filed Sep. 15, 2013, by Paul V. Cooper, U.S. Pat. No. 8,535,603 entitled ROTARY DEGASSER AND ROTOR THEREFOR, U.S. Pat. No. 8,613,884 entitled LAUNDER TRANSFER METAL-TRANSFER CONDUIT AND DEVICE, U.S. Pat. No. 8,714,914 entitled MOLTEN METAL PUMP FILTER, U.S. Pat. No. 8,753,563 entitled DEVICE AND METHOD FOR DEGASSING MOLTEN METAL, U.S. Pat. No. 9,011,761 entitled LADLE WITH TRANSFER CONDUIT, U.S. Pat. No. 9,017,597 entitled TRANSFERRING MOLTEN METAL USING NON-GRAVITY ASSIST LAUNDER, U.S. Pat. No. 9,034,244 entitled GAS-TRANSFER FOOT, U.S. Pat. No. 9,080,577 entitled SHAFT AND POST TENSIONING DEVICE, U.S. Pat. No. 9,108,244 entitled IMMERSION HEATHER FOR MOLTEN METAL, U.S. Pat. No. 9,156,087 entitled MOLTEN METAL TRANSFER DEVICE AND ROTOR, U.S. Pat. No. 9,205,490 entitled TRANSFER WELL DEVICE AND METHOD FOR MAKING SAME, U.S. Pat. No. 9,328,615 entitled ROTARY DEGASSERS AND COMPONENTS THEREFOR, U.S. Pat. No. 9,377,028 entitled TENSIONING DEVICE EXTENDING BEYOND COMPONENT, U.S. Pat. No. 9,382,599 entitled ROTARY DEGASSER AND ROTOR THEREFOR, U.S. Pat. No. 9,383,140 entitled TRANSFERRING MOLTEN METAL FROM ONE STRUCTURE TO ANOTHER, U.S. Pat. No. 9,409,232 entitled MOLTEN METAL TRANSFER VESSEL AND METHOD OF CONSTRUCTION, U.S. Pat. No. 9,410,744 entitled VESSEL TRANSFER METAL-TRANSFER CONDUIT AND DEVICE, U.S. Pat. No. 9,422,942 entitled TENSION DEVICE WITH INTERNAL PASSAGE, U.S. Pat. No. 9,435,343 entitled GAS-TRANSFER FOOT, U.S. Pat. No. 9,464,636 entitled TENSION DEVICE GRAPHITE COMPONENT USED IN MOLTEN METAL, U.S. Pat. No. 9,470,239 THREADED TENSIONING DEVICE, 9,481,035 entitled IMMERSION HEATER FOR MOLTEN METAL, U.S. Pat. No. 9,482,469 entitled VESSEL TRANSFER METAL-TRANSFER CONDUIT AND DEVICE, U.S. Pat. No. 9,506,129 entitled ROTARY DEGASSER AND ROTOR THEREFOR, U.S. Pat. No. 9,566,645 entitled MOLTEN METAL TRANSFER DEVICE AND ROTOR, 9,581,388 entitled VESSEL TRANSFER METAL-TRANSFER CONDUIT AND DEVICE, U.S. Pat. No. 9,587,883 entitled LADLE WITH TRANSF ER CONDUIT, U.S. Pat. No. 9,643,247 entitled MOLTEN METAL TRANSFER AND DEGASSING DEVICE, U.S. Pat. No. 9,657,578 entitled ROTARY DEGASSERS AND COMPONENTS THEREFOR, U.S. Pat. No. 9,855,600 entitled MOLTEN METAL TRANSFER DEVICE AND ROTOR, U.S. Pat. No. 9,862,026 entitled METHOD OF FORMING TRANSFER WELL, U.S. Pat. No. 9,903,383 entitled MOLTEN METAL ROTOR WITH HARDENED TOP, U.S. Pat. No. 9,909,808 entitled DEVICE AND METHOD FOR DEGASSING MOLTEN METAL, U.S. Pat. No. 9,925,587 entitled METHOD OF TRANSFERRING MOLTEN METAL FROM A VESSEL, entitled U.S. Pat. No. 9,982,945 MOLTEN METAL TRANSFER VESSEL AND METHOD OF CONSTRUCTION, U.S. Pat. No. 10,052,688 entitled TRANSFER PUMP LAUNDER DEVICE, U.S. Pat. No. 10,072,891 entitled TRANSFERRING MOLTEN METAL USING NON-GRAVITY ASSIST LAUNDER, U.S. Pat. No. 10,126,058 entitled MOLTEN METAL TRANSFERRING VESSEL, U.S. Pat. No. 10,126,059 entitled CONTROLLED MOLTEN METAL FLOW FROM TRANSFER VESSEL, U.S. Pat. No. 10,138,892 entitled ROTOR AND ROTOR SHAFT FOR MOLTEN METAL, U.S. Pat. No. 10,195,664 entitled MULTI-STAGE IMPELLER FOR MOLTEN METAL, U.S. Pat. No. 10,267,314 entitled TENSIONED SUPPORT SHAFT AND OTHER MOLTEN METAL DEVICES, U.S. Pat. No. 10,274,256 entitled VESSEL TRANSFER DEVICES AND DEVICES, U.S. Pat. No. 10,302,361 entitled TRANSFER VESSEL FOR MOLTEN METAL PUMPING DEVICE, U.S. Pat. No. 10,309,725 entitled IMMERSION HEATER FOR MOLTEN METAL, U.S. Pat. No. 10,307,821 entitled TRANSFER PUMP LAUNDER DEVICE, 10,322,451 entitled TRANSFER PUMP LAUNDER DEVICE, U.S. Pat. No. 10,345,045 entitled VESSEL TRANSFER METAL-TRANSFER CONDUIT AND DEVICE, U.S. Pat. No. 10,352,620 entitled TRANSFERRING MOLTEN METAL FROM ONE STRUCTURE TO ANOTHER, U.S. Pat. No. 10,428,821 entitled QUICK SUBMERGENCE MOLTEN METAL PUMP, U.S. Pat. No. 10,458,708 entitled TRANSFERRING MOLTEN METAL FROM ONE STRUCTURE TO ANOTHER, U.S. Pat. No. 10,465,688 entitled COUPLING AND ROTOR SHAFT FOR MOLTEN METAL DEVICES, U.S. Pat. No. 10,562,097 entitled MOLTEN METAL TRANSFER DEVICE AND ROTOR, U.S. Pat. No. 10,570,745 entitled ROTARY DEGASSERS AND COMPONENTS THEREFOR, U.S. Pat. No. 10,641,279 entitled MOLTEN METAL ROTOR WITH HARDENED TIP, U.S. Pat. No. 10,641,270 entitled TENSIONED SUPPORT SHAFT AND OTHER MOLTEN METAL DEVICES, U.S. patent application Ser. No. 16/877,267 entitled MOLTEN METAL CONTROLLED FLOW LAUNDER, which was filed on May 18, 2020, U.S. application Ser. No. 16/877,296 entitled SYSTEM AND METHOD TO FEED MOLD WITH MOLTEN METAL, which was filed on May 18, 2020, U.S. application Ser. No. 16/877,332 entitled SMART MOLTEN METAL PUMP, which was filed on May 18, 2020, U.S. application Ser. No. 16/877,182 entitled SYSTEM FOR MELTING SOLID METAL, which was filed on May 18, 2020, U.S. application Ser. No. 16/877,219 entitled METHOD FOR MELTING SOLID METAL, which was filed on May 18, 2020, U.S. Provisional Patent Application Ser. No. 62/849,787 filed on May 17, 2019 and entitled MOLTEN METAL PUMPS, COMPONENTS, DEVICES AND METHODS, and U.S. Provisional Patent Application Ser. No. 62/852,846 filed on May 24, 2019 and entitled SMART MOLTEN METAL PUMP.

Three basic types of pumps for pumping molten metal, such as molten aluminum, are utilized: circulation pumps, transfer pumps and gas-release pumps. Circulation pumps are used to circulate the molten metal within a bath, thereby generally equalizing the temperature of the molten metal. Circulation pumps may be used in any vessel, such as in a reverbatory furnace having an external well. The well is usually an extension of the charging well, in which scrap metal is charged (i.e., added).

Standard transfer pumps are generally used to transfer molten metal from one structure to another structure such as a ladle or another furnace. A standard transfer pump has a riser tube connected to a pump discharge and supported by the superstructure. As molten metal is pumped it is pushed up the riser tube (sometimes called a riser) and out of the riser tube, which generally has an elbow at its upper end, so molten metal is released into a different vessel from which the pump is positioned.

Gas-release pumps, such as gas-injection pumps, circulate molten metal while introducing a gas into the molten metal. In the purification of molten metals, particularly aluminum, it is frequently desired to remove dissolved gases such as hydrogen, or dissolved metals, such as magnesium. As is known by those skilled in the art, the removing of dissolved gas is known as “degassing” while the removal of magnesium is known as “demagging.” Gas-release pumps may be used for either of both of these purposes or for any other application for which it is desirable to introduce gas into molten metal.

Gas-release pumps generally include a gas-transfer conduit having a first end that is connected to a gas source and a second end submerged in the molten metal bath. Gas is introduced into the first end and is released from the second end into the molten metal. The gas may be released downstream of the pump chamber into either the pump discharge or a riser extending from the discharge, or into a stream of molten metal exiting either the discharge or the riser. Alternatively, gas may be released into the pump chamber or upstream of the pump chamber at a position where molten metal enters the pump chamber. The gas may also be released into any suitable location in a molten metal bath.

Molten metal pump casings and rotors often employ a bearing device comprising ceramic rings wherein there are one or more rings on the rotor that align with rings in the pump chamber (such as rings at the inlet and outlet) when the rotor is placed in the pump chamber. The purpose of the bearing device is to reduce damage to the soft, graphite components, particularly the rotor and pump base, during pump operation.

Generally, a degasser (also called a rotary degasser) for molten metal, such as molten aluminum, includes (1) an impeller shaft having a first end, a second end and a passage for transferring gas, (2) an impeller, and (3) a drive source for rotating the impeller shaft and the impeller. The first end of the impeller shaft is connected to the drive source and to a gas source and the second end is connected to the impeller.

Generally, a scrap melter for molten metal (particularly molten aluminum) includes an impeller affixed to an end of a drive shaft, and a drive source attached to the other end of the drive shaft for rotating the shaft and the impeller. The movement of the impeller draws molten metal and scrap metal downward into the molten metal bath in order to melt the scrap. A circulation pump is often used in conjunction with the scrap melter to circulate the molten metal in order to maintain a relatively constant temperature within the molten metal.

The materials forming the components that contact the molten metal bath should remain relatively stable in the bath. Structural refractory materials, such as graphite or ceramics, that are resistant to disintegration by corrosive attack from the molten metal may be used. As used herein “ceramics” or “ceramic” refers to any oxidized metal (including silicon, such as silicon dioxide) or carbon-based material, excluding graphite, or other ceramic material capable of being used in a molten metal. “Graphite” means any type of graphite, whether or not chemically treated. Graphite is suitable for being formed into pump components because it is (a) soft and relatively easy to machine, (b) not as brittle as ceramics and less prone to breakage, and (c) less expensive than ceramics. Ceramic, however, is more resistant to corrosion by molten aluminum than graphite.

Some devices or systems used to transfer molten metal include a molten metal pump and a molten riser (or riser). The molten metal pump may have a pump base with a pump chamber in which a rotor is positioned, and a discharge that extends from the pump chamber to a pump outlet formed in a side of the pump base. The riser has a metal-transfer inlet (or transfer inlet) in fluid communication with the pump outlet. In prior devices there was often a gap between the pump outlet and the transfer inlet so more pump speed was required to raise the level of molten metal in the riser. Alignment of the pump outlet with the transfer inlet of the riser would be an advantage. The better the alignment, the less pressure required from the pump to push molten metal from the outlet of the pump base into the riser, up the passage of the riser, and out of the transfer outlet.

### SUMMARY

Disclosed is a device that includes (1) a pump having a rotor configured to push molten metal upwards, and (2) a riser in which the rotor and a rotor shaft are at least partially positioned. The riser has an inner conduit (or “conduit” or “passage”), an inlet at or near the bottom of the riser, and an outlet above the inlet and below the pump motor. The pump rotates the rotor shaft and the rotor, and as molten metal enters the inlet the rotor pushes the molten metal upwards in the conduit until the molten metal exits the outlet. A launder or other structure is preferably connected to the riser outlet so molten metal exiting the outlet enters such a structure and is transferred.

The conduit is two-stage with a lower stage having a first width and that is generally cylindrical. An upper stage is above the lower stage and has a second width that may be the same as the first width or different from the first width. In one embodiment, the upper stage has a cross-section with a substantially circular center and one or more lobes extending from and in communication with the center, wherein the purpose of the one or more lobes is to help prevent the formation of a vortex. If vortex forms it could create turbulence that disrupts the flow of molten metal and draws in air, which can create dross as oxygen mixes with the molten metal.

### BRIEF DESCRIPTION OF THE DRAWINGS

FIG. 1 is a side, perspective view of a device according to this disclosure.

FIG. 2 is a side, perspective, exploded view of the device of FIG. 1.

FIG. 3 is a top view of the device of FIG. 1.

FIG. 4 is a front, partial cross-sectional view of the device of FIG. 1.

FIG. 5 is a side, partial cross-sectional view of the device of FIG. 1.

FIG. 6 is a rear view of the device of FIG. 1.

FIG. 7 is a perspective, front view of the device of FIG. 1.

FIG. 8 is a top view of the device of FIG. 7.

FIG. 9 is a cross-sectional side view taken along line A-A of FIG. 8.

FIG. 10 is a front, partial cross-sectional view of the pump base of FIG. 1.

FIG. 11 is a cross-sectional view taken along line B-B of FIG. 10.

FIG. 12 is a cross-sectional view taken through line C-C of FIG. 10.

FIG. 13 is a top view of a riser according to this disclosure.

FIG. 14 is a side, cross-sectional view taken along line D-D of FIG. 14.

FIG. 15 is a front, perspective, partial cross-sectional view of the riser of FIGS. 13 and 14.

### DETAILED DESCRIPTION

Turning now to the drawings, where the purpose is to describe a preferred embodiment of the invention and not to limit same, a device 10 generally includes a pump 100 and a riser 500.

### Pump

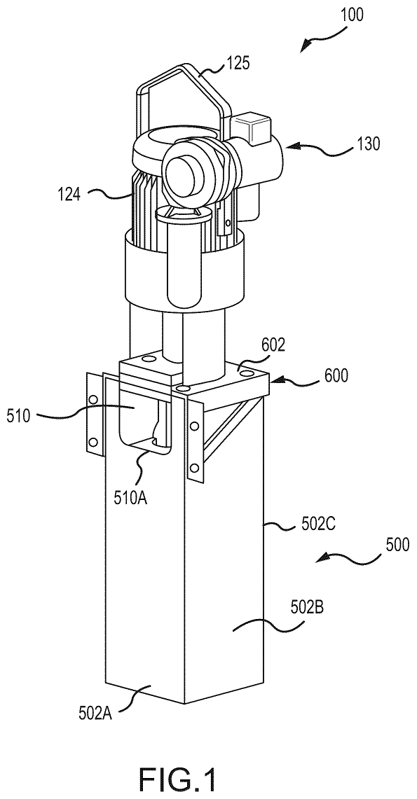

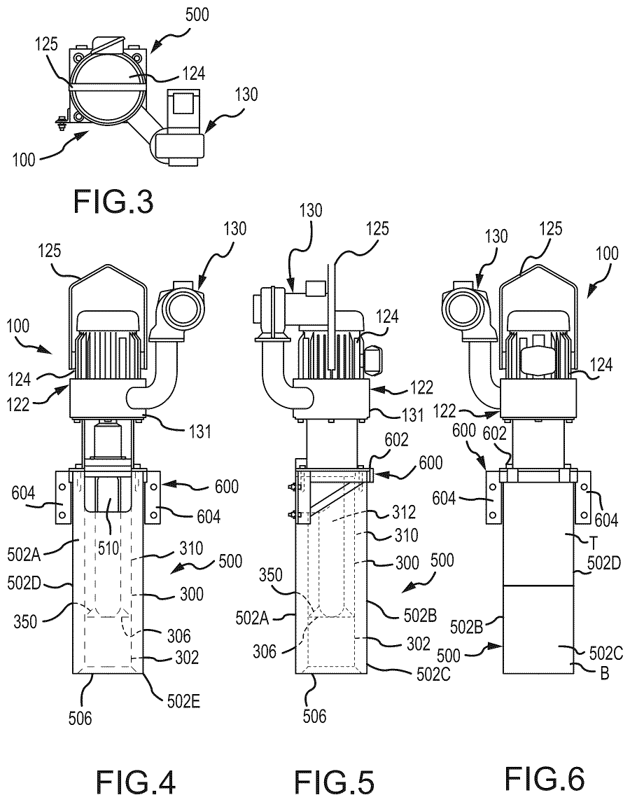

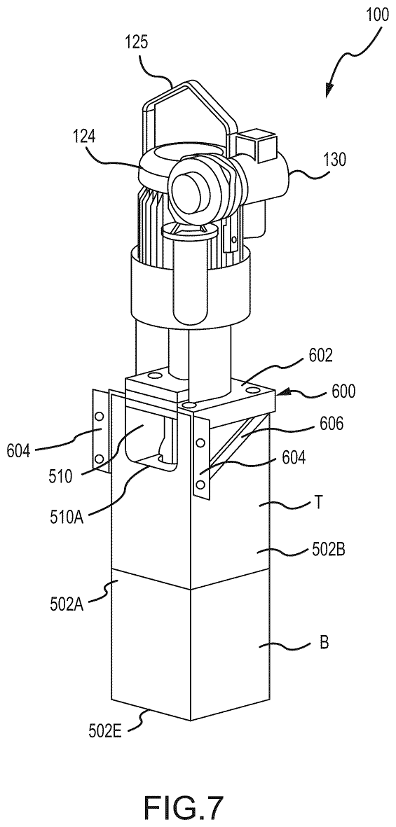

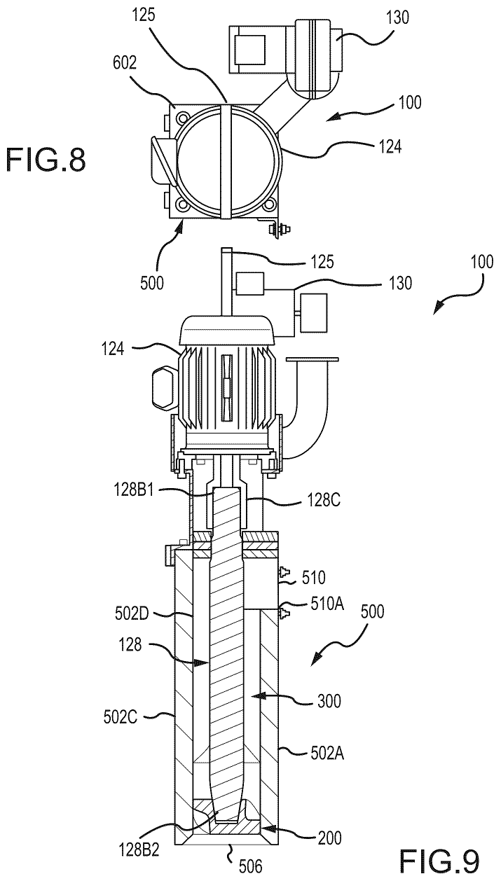

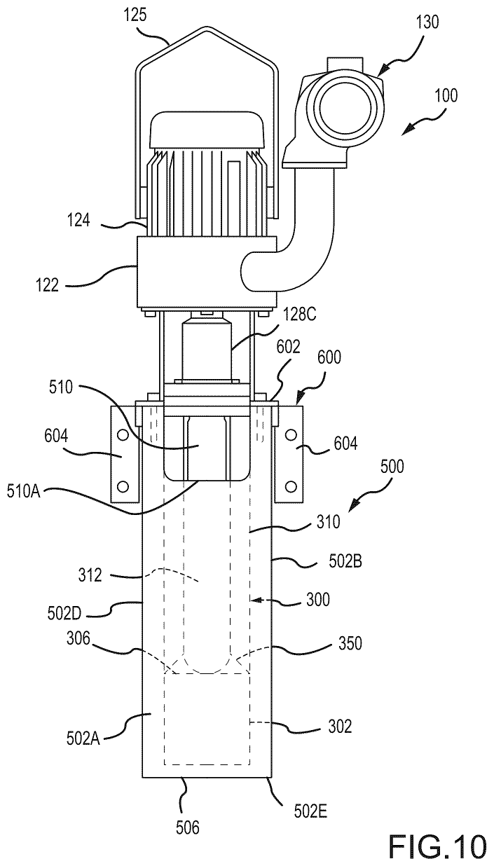

As seen, for example, in FIGS. 1-10, pump 100 is of any suitable design (and can be a circulation pump or gas-release pump) satisfactory to move molten metal upwards in conduit 300 of in the riser 500 as described herein. The pump 100 preferably has a pump support (or “support” or “weldment”) 122, a drive source 124 (which is most preferably a pneumatic motor) mounted on the support 122, and a drive shaft 128. Motor 124 as shown is secured (at least in part) to support 122 by a strap 125. Motor 124 preferably is partially surrounded by a cooling shroud 131 that circulates air generated by blower 130, which is known in the art.

Drive shaft 128 preferably includes a motor drive shaft 128A that extends downward from the motor 124, a rotor shaft 128B, and a coupling 128C. Motor drive shaft 128A is preferably comprised of steel. Rotor drive shaft (or rotor shaft) 128B is preferably comprised of graphite, or graphite coated with a ceramic, but can be comprised of any suitable material. Coupling 128C is preferably comprised of steel and connects the motor drive shaft 128A to the first end 128B1 of the rotor drive shaft 128B.

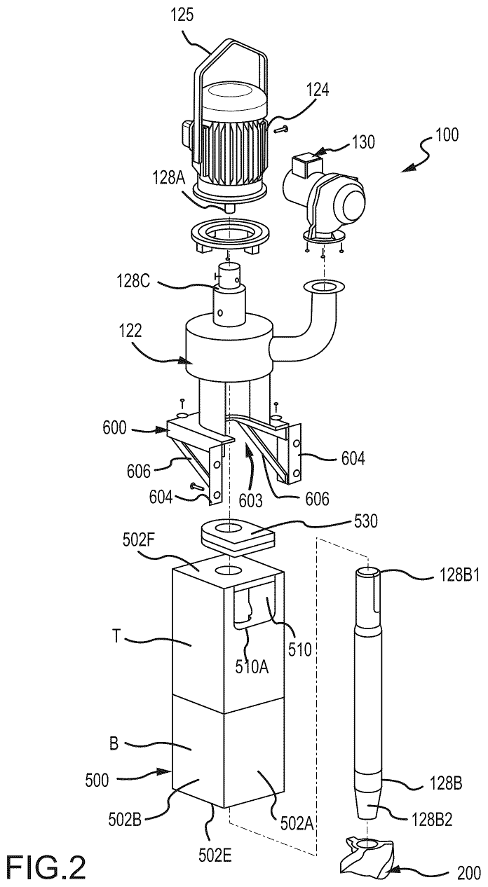

A rotor 200, best seen in FIG. 2, is positioned in the conduit 300 and is connected to a second end 128B2 of the rotor shaft 128B. Rotor 200 is configured to push molten metal upwards and it may be a two-stage rotor with blades that each include an angled section to push molten metal up into conduit 300.

The components of pump 100 that are immersed in molten metal, such as the rotor 200 and rotor shaft 128, are preferably comprised of graphite and/or ceramic. Pump 100 as shown has no support posts or pump base.

### Riser

Riser 500 is configured to have pump 100 positioned thereon with rotor shaft 128B and rotor 200 positioned at least partially in the conduit 300. Riser 500 as shown is a generally rectangular structure, but can be of any suitable shape or size, wherein the size depends at least in part on the size of the pump with which the riser 500 is used. Outlet 510 is of any suitable size and shape to permit molten metal to pass through it, and is above inlet 506 and below motor 124.

Riser 500 is preferably comprised of material capable of withstanding the heat and corrosive environment of molten metal (particularly molten aluminum). Most preferably the heat resistant material is a high temperature, castable cement, with a high silicon carbide content, such as ones manufactured by AP Green or Harbison Walker, each of which are part of ANH Refractory, based at 400 Fairway Drive, Moon Township, PA 15108, or Allied Materials, and riser 500 is cast or otherwise formed in any suitable manner. Cement (if used) to connect riser 500 to another structure is of a type known by those skilled in the art.

The riser 500 may have a bottom portion B and a top portion T. The bottom portion is preferably comprised of or consists of graphite because graphite is relatively inexpensive and simple to machine. The top portion may be comprised of ceramic such as silicon carbide, which is harder than graphite and also more resistant to corrosion. Alternatively, riser 500 may be comprised entirely of graphite or entirely of ceramic.

Riser 500 as shown has four sides 502A, 502B, 502C and 502D, a bottom 502E a top 502F, an inlet 506, a conduit 300, and an outlet 510.

Inlet 506 functions to allow molten metal to pass through it and into conduit 300. As shown, inlet 506 is formed in bottom 502E, and riser 500 can be raised from the bottom surface of a vessel into which it is positioned in any suitable manner to allow molten metal to enter inlet 506. For example, riser 500 may be suspended or have gaps formed in one or more sides 502A, 502B, 502C, 502D to permit molten metal to enter inlet 506. Alternatively, riser 500 may have support legs or it may rest on a support in order to position bottom 502E above the bottom surface of a vessel in which device 10 is positioned.

Alternatively, inlet 506 may be formed in any of sides 502A, 502B, 502C, or 502D, preferably starting about 0″-2″, 2″-6″, or 1.5″-3″, from bottom surface 502E. If formed in a side surface of riser 500, inlet 506 could have a height of about 2″-4″ (or about 3.25″) and a width of about 4″-6″ (or about 5″). If the inlet 506 is in bottom 502E as shown, it may have a cross-sectional area that is 5%-10%, 10%-20%, 20%-30%, 30%-40%, 40%-50%, or any amount from 5%-50% larger (or smaller) than the cross-sectional area of lower stage 302 of conduit 300. The cross-sectional area of inlet 506 is measured at the outer surface on which it is located, such as the outer surface of bottom 502E. Inlet 506 can be of any suitable size and shape, and as shown flares outward from bottom stage 302 of conduit 300 and is about 3% to 10% wider at bottom 502E than the width of lower stage 302. As shown, inlet 506 has a width at bottom 502E that is greater than 50% of the width, or about 75%-85% the width of bottom 502E as measured along side 502A, 502B, 502C, or 502D.

Insulation 530 is positioned between the pump motor support and the surface 502F of riser 500.

### Conduit

Conduit 300 has two stages, lower stage 302 and upper stage 310, and a transition 350 that connects lower stage 302 and upper stage 310. Lower stage 302 is preferably cylindrical and has a circular cross section (as shown, for example, in FIG. 12), although lower stage 302 could be of any suitable shape. Lower stage 302 has a cross-sectional diameter that as shown is greater than ½ the width of riser 300, and it can be between 30%-70%, or 40%-75%, or 50% or more, or 60% or more of the width of riser 500. Lower stage 302 has a bottom 304 that connects to and communicates with inlet 506 and a top 306 that connects to and communicates with transition 350. As shown, lower stage 302 has a height of about 25%-35% of the height of riser 500 and about 30%-40% of the height of conduit 300, although lower stage 302 could be of any suitable height. Conduit 300's height is measured from bottom 304 to the lower lip 510A of outlet 510.

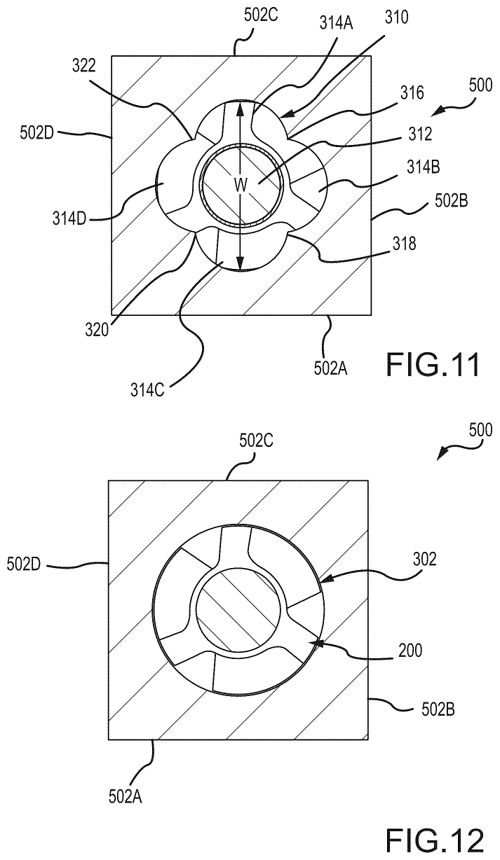

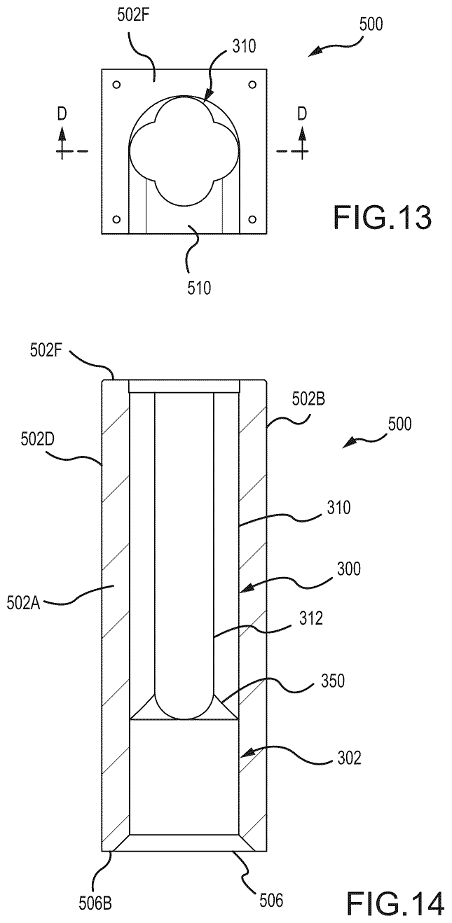

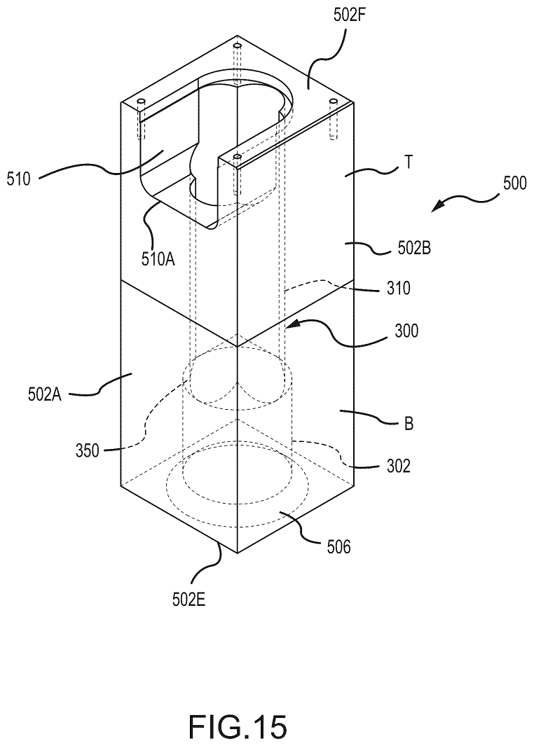

Upper stage 310 has a clover-leaf cross-sectional shape (as shown, for example, in FIG. 11). Upper stage 310 includes, in cross section, a circular center 312 and four lobes 314A, 314B, 314C, and 314D, connected to and in communication with circular center 312. The purpose of the lobes is to help prevent a vortex from forming as molten metal is being pumped up through conduit 300.

Although four lobes are shown, one or more lobes, or a plurality of lobes, may be utilized, as long as they are of sufficient number, size and shape to prevent a vortex from forming under normal pump operating parameters.

As shown, the cross-sectional area of lower stage 302 is greater than the cross-sectional area of upper stage 310, although any suitable cross-sectional area for lower stage 302 and upper stage 310 may be utilized. The cross-sectional width W1 of upper stage 310 as measured across lobe 314A and lobe 314C is the same as the cross-sectional width of lower stage 302, although W1 could be any suitable width. The cross-sectional width as measured across lobe 314B and lobe 314D is also W1 and is the same as the cross-sectional width of lower stage 302, although the width as measured across lobes 314B and 314D need not be the same as W1 and need not be the same as the cross-sectional width of lower stage 302.

Each lobe shares a connecting point with an adjacent lobe. Lobe 314A has a connecting point 316 with lobe 314B. Lobe 314B has a connecting point 318 with lobe 314C. Lobe 314C has a connecting point 320 with lobe 314D. Lobe 314D has a connecting point 322 with lobe 314A. As shown, the cross-sectional width from connecting point 316 to connecting point 320 and from connecting point 318 to connecting point 322 are the same, although they need not be the same. Additionally, the cross-sectional width between the connecting points is less than the cross-section width of lower stage 302 and is about 10%, 20%, 30%, 10%-20%, 15%-25%, or 15%-30% less than the cross-sectional width W1, although any suitable width may be used.

### Clamp

Clamp 600 is preferably comprised of steel and has a plate 602 having an opening 603 that is configured to be positioned on top surface 502F of riser 500 and be connected thereto by suitable fasteners. Side portions 604 extend downward on side 502A along the sides of outlet 510 and are preferably fastened to side 502A. Cross bars 606 help maintain the stability of clamp 600.

### Operation

In operation, when the motor 100 is activated it rotates the rotor shaft 128 and rotor 200. The rotor 200 pumps molten metal upwards through the lower stage 302 of the conduit 300, into the upper stage 310 of the conduit, and out of the outlet 510. The one or more lobes 314A, 314B, 314C, and 314D help to stop a vortex from forming. A vortex can lead to turbulent flow of the molten metal and the formation of dross because the molten metal contacts more air and hence more oxygen. The outlet 510 may be connected to a pipe, launder or other structure that further transfers the molten metal.

Some non-limiting examples of this disclosure are as follows:
Example 1: A device for pumping molten metal, the device comprising:
   (a) a pump configured for pumping molten metal, wherein the pump comprises (i) a motor, (ii) a shaft having a first end connected to the motor, and a second end connected to a rotor, wherein the rotor is configured to push molten metal upwards; and
   (b) a riser having an outer surface, a front, a bottom, an inlet, an outlet above the inlet, and a two-stage conduit having an upper stage comprising a first cross-sectional area and a lower stage beneath the upper stage, wherein the lower stage has a second cross-sectional area that is greater than the first cross-sectional area.
Example 2: The device of example 1, wherein the pump further includes a platform on which the motor is positioned, and the platform is attached to a clamp, and the clamp is further attached to the top portion of the riser.
Example 3: The device of example 1, wherein the bottom portion of the riser is comprised of graphite and the top portion of the riser is comprised of ceramic.
Example 4: The device of example 2, wherein the second cross-sectional area is 25% or more greater than the first cross-sectional area.
Example 5: The device of example 1 that further includes a transition between the upper stage and the lower stage.
Example 6: The device of example 6, wherein the transition expands from the first cross-sectional area where it connects to the upper stage to the second cross-sectional area where it connects to the lower stage.
Example 7: The device of example 6, wherein the transition has a height that is less than a height of the lower stage.
Example 8: The device of example 6, wherein the transition has a height that is less than a height of the upper stage.
Example 9: The device of example 1, wherein the upper stage has a clover-shaped cross section.
Example 10: The device of example 2, wherein the lower stage has a circular cross section.
Example 11: The device of example 2, wherein the upper stage has a cross-section comprising a circular center and a plurality of lobes extending from and connected to the circular center.
Example 12: The device of example 11 that has four lobes.
Example 13: The device of example 11 that has between one and four lobes.
Example 14: The device of example 1, wherein a distance between the outlet and the inlet is 2 feet or more.
Example 15: The device of example 3, wherein the clamp has a plate attached to a top surface of the metal transfer conduit and the clamp is also attached to the platform.
Example 16: The device of example 15, wherein the clamp further includes side arms connected to a side of the riser.
Example 17: The device of example 15, wherein the clamp further includes a step-up section that connects the first plate to the second plate, wherein the step-up section is connected to a side of the platform.
Example 18: The device of example 3, wherein the riser has grooves in two sides and the clamp has side plates with ridges that are received in the grooves.
Example 19: The device of example 11, wherein each of the plurality of lobes has the same size and shape as the other of the plurality of lobes.
Example 20: The device of example 11, wherein each of the plurality of lobes is formed at a 90° angle to the adjacent each of the other plurality of lobes.
Example 21: The device of any one of examples 1-21 that includes insulation between the motor support and the top of the riser.
Example 22: The device of any one of examples 11-13 or 19-20, wherein the center portion of the upper stage of the conduit has a width, and each of the one or more lobes has a width, and the width of the center portion is greater than the width of each of the one or more lobes.
Example 23: The device of any one of examples 11-13, 19-20, or 22, wherein each of the plurality of lobes is spaced equidistantly about the center portion.
Example 24: The device of any one of examples 1-23, wherein the lower stage has a cross-sectional width and the circular portion of the upper stage has a cross-sectional width and the cross-sectional width of the lower stage is greater than the cross-sectional width of the circular portion of the upper stage.
Example 25: The device of example 27, wherein the cross-sectional width of the lower stage is 50%-100% greater than the width of the center portion of the upper stage.
Example 26: The device of any one of examples 1-25, wherein the inlet is in the bottom surface.
Example 27: The device of any one of examples 1-11 or 12-27, wherein the upper stage has at least two lobes in either side of the center portion and a distance between measured between the ends of the lobes, wherein the distance is equal to the cross-sectional width of the lower stage of the conduit.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A device for pumping molten metal, the device comprising:
(a) a pump configured for pumping molten metal, wherein the pump comprises (i) a motor, (ii) a shaft having a first end connected to the motor, and a second end connected to a rotor, wherein the rotor is configured to push molten metal upwards; and
(b) a riser having an inlet, an outlet above the inlet, and a conduit, wherein the conduit comprises a cross-section comprising a circular center and a plurality of lobes extending from and connected to the circular center.

2. The device of claim 1, wherein the cross-section comprises four lobes.

3. The device of claim 1, wherein each lobe shares a connecting point with an adjacent lobe.

4. The device of claim 3, wherein the conduit comprises a lower stage conduit and an upper stage conduit, wherein the upper stage conduit comprises the cross-section comprising the circular center and the plurality of lobes, and wherein a cross-sectional width between connecting points is less than a cross-section width of the lower stage conduit.

5. The device of claim 4, wherein the cross-sectional width between connecting points is about 10% to 20% less than the cross-section width of the lower stage conduit.

6. The device of claim 1, wherein each of the plurality of lobes has the same size and shape as the other of the plurality of lobes.

7. The device of claim 1, wherein the conduit comprises at least two lobes on opposing sides of a center portion and a width between the lobes.

8. The device of claim 1, wherein the plurality of lobes help prevent the formation of a vortex.

9. The device of claim 1, wherein each of the plurality of lobes is spaced equidistantly about the center portion.

10. The device of claim 1, wherein the pump further comprises a platform on which the motor is positioned, and the platform is attached to a clamp, and the clamp is further attached to the top of the riser.

11. The device of claim 1, wherein the riser comprises a bottom portion comprised of graphite and a top portion comprised of ceramic.

12. The device of claim 1, wherein the riser comprises a lower stage, an upper stage, and a transition between the upper stage and the lower stage.

13. The device of claim 12, wherein the transition expands from the first cross-sectional area where it connects to the upper stage to the second cross-sectional area where it connects to the lower stage.

14. The device of claim 12, wherein the transition has a height that is less than a height of the lower stage.

15. The device of claim 12, wherein the transition has a height that is less than a height of the upper stage.

16. A device for pumping molten metal, the device comprising:
(a) a pump configured for pumping molten metal, wherein the pump comprises (i) a motor, (ii) a shaft having a first end connected to the motor, and a second end connected to a rotor, wherein the rotor is configured to push molten metal upwards; and
(b) a riser comprising an inlet, an outlet above the inlet, and a two-stage inner conduit comprising an upper stage conduit and a lower stage-conduit beneath the upper stage conduit, wherein the upper stage conduit has a larger cross-sectional area than the lower stage conduit.

17. The device of claim 16, wherein a cross-sectional area of the inlet is larger than a cross-sectional area of the lower stage conduit.

18. The device of claim 17, wherein the cross-sectional area of the inlet is 5% to 50% larger than the cross-sectional area of the lower stage conduit.

19. The device of claim 16, wherein the two-stage inner conduit comprises a cross-section comprising a circular center and a plurality of lobes extending from and connected to the circular center.

20. The device of claim 16, wherein the two-stage inner conduit comprises a transition from the lower stage conduit to the upper stage conduit.
